(19) United States
(12) Patent Application Publication
(10) Pub. No.: US 2013/0233283 A1
(43) Pub. Date: Sep. 12, 2013

(54) BIMETALLIC THERMOSTATIC FLOW VALVE FOR DIESEL FUEL SYSTEMS

(71) Applicants: Gordon G. Rinke, Sterling Heights, MI (US); William L. Villaire, Clarkston, MI (US); Jeffery J. Milton, Lake Orion, MI (US); Ryan A. Buccafurri, Royal Oak, MI (US)

(72) Inventors: Gordon G. Rinke, Sterling Heights, MI (US); William L. Villaire, Clarkston, MI (US); Jeffery J. Milton, Lake Orion, MI (US); Ryan A. Buccafurri, Royal Oak, MI (US)

(73) Assignee: GM GLOBAL TECHNOLOGY OPERATIONS LLC, Detroit, MI (US)

(21) Appl. No.: 13/595,220

(22) Filed: Aug. 27, 2012

Related U.S. Application Data
(60) Provisional application No. 61/608,868, filed on Mar. 9, 2012.

(51) Int. Cl. F02M 37/04; G05D 23/02

(52) U.S. Cl. 123/495; 236/93 R

(57) ABSTRACT

A fuel system for a diesel engine is provided that includes a fuel supply tank module for storing fuel. The fuel supply tank module includes a fuel pump module reservoir which has an in-tank low pressure lift pump and a bimetallic thermostatic flow valve. The fuel system also includes a fuel filter module for filtering fuel pumped from the fuel supply tank module, a high pressure pump for pumping fuel from the fuel filter module, a diesel engine for receiving fuel from the high pressure pump, and a fuel return line for returning fuel to the bimetallic thermostatic flow valve. The bimetallic thermostatic flow valve includes a bimetallic element in thermal communication with the returning fuel. The bimetallic element deflects in response to the thermal communication so that returning fuel flows to at least one of the fuel pump module reservoir and the in-tank low pressure lift pump.

### CROSS-REFERENCE TO RELATED APPLICATIONS

This application claims the benefit of U.S. Provisional Patent Application No. 61/608,868 filed on Mar. 9, 2012, the disclosure of which is hereby incorporated by reference.

### TECHNICAL FIELD

This invention relates to a fuel system for a diesel engine and, more particularly, to a bimetallic thermostatic flow valve for such systems.

### BACKGROUND

In a conventional diesel engine, the fuel system provides excess or surplus fuel to the engine. This excess fuel is heated during the engine operation and then may be returned to the fuel tank. It is known that when diesel fuel is below certain low temperatures, paraffin wax crystals will solidify in the fuel. When the crystals begin to appear, they can accumulate on the fuel filter. Additionally, if too much heat builds up in the fuel flowing to the engine, the system may not perform at an optimum level. Current systems use a wax element in a flow valve to direct hot or cool return fuel as desired.

### SUMMARY

A fuel system for a diesel engine is provided that includes a fuel supply tank module for storing fuel. The fuel supply tank module includes a fuel pump module reservoir which has an in-tank low pressure lift pump and a bimetallic thermostatic flow valve inside the fuel pump module reservoir. The fuel system also includes a fuel filter module connected to the in-tank low pressure lift pump for filtering fuel pumped from the fuel supply tank module, a high pressure pump connected to the fuel filter module for pumping fuel from the fuel filter module, a diesel engine connected to the high pressure pump for receiving fuel from the high pressure pump, and a fuel return line connected from the diesel engine to the bimetallic thermostatic flow valve for returning fuel to the bimetallic thermostatic flow valve. The bimetallic thermostatic flow valve includes a bimetallic element, which is in thermal communication with the returning fuel. The returning fuel flows through the bimetallic thermostatic flow valve causing the bimetallic element to deflect in response to the thermal communication so that fuel flows to at least one of the fuel pump module reservoir and the in-tank low pressure lift pump. Thus, when the temperature of the returning fuel is below a predetermined temperature range, the bimetallic element deflects so that fuel flows to the in-tank low pressure lift pump, and undesirable effects of cold fuel can be reduced. Additionally, when the temperature of the returning fuel is above the predetermined temperature range, the bimetallic element deflects so that fuel flows to the fuel pump module reservoir, and excessive heat can be dissipated.

In a first and a second embodiment, the bimetallic thermostatic flow valve has a valve body including a fuel return port, a fuel pump module reservoir port, a fuel supply port, and a fuel chamber connected to the fuel return port and through which returning fuel flows. The bimetallic element extends into the fuel chamber and is in thermal communication with the returning fuel. The returning fuel causes the bimetallic element to deflect in response to the thermal communication so that fuel flows to at least one of the fuel pump module reservoir port and the fuel supply port. The bimetallic element directs fuel by deflecting or lengthening in response to a temperature of fuel flowing through the fuel return port. When the temperature of the returning fuel is within a predetermined temperature range, the bimetallic element does not deflect fully so the return fuel is directed to be split between both the fuel supply port and the fuel pump module reservoir port depending on the amount of the deflection. When the temperature of the returning fuel is below the predetermined temperature range, then the bimetallic element deflects sufficiently to direct the returning fuel to the fuel supply port. When the temperature of the returning fuel is above the predetermined temperature range, then the bimetallic element deflects sufficiently to direct the returning fuel to the fuel pump module reservoir port.

In another embodiment, a bimetallic thermostatic flow valve includes a generally cylindrical valve body having a bend and having at least one aperture. The generally cylindrical valve body has a fuel return port and a fuel supply port for directing returning fuel flow. The aperture has a bimetallic element covering it. The bimetallic element deflects away from the at least one aperture in response to a predetermined temperature of returning fuel flowing through the generally cylindrical valve body.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of a fuel system for a diesel engine including a bimetallic thermostatic flow valve constructed in accordance with the teachings of the present invention.

FIG. 2 is a cross-sectional illustration of a first embodiment of the bimetallic thermostatic flow valve of the present invention with a bimetallic element in a deflectable plate form in a neutral design position.

FIG. 3 is a cross-sectional illustration showing the fuel flow through the bimetallic thermostatic flow valve with the bimetallic element in a deflectable spring form in the neutral design position of FIG. 2.

FIG. 4 is a cross-sectional illustration of the first embodiment of the bimetallic thermostatic flow valve of the present invention with the bimetallic element in the deflectable plate form in a hot start design position.

FIG. 5 is a cross-sectional illustration showing the fuel flow through the bimetallic thermostatic flow valve with the bimetallic element in the deflectable spring form in the hot start design position of FIG. 4.

FIG. 6 is a cross-sectional illustration of the first embodiment of the bimetallic thermostatic flow valve of the present invention with the bimetallic element in the deflectable plate form in a cold start design position.

FIG. 7 is a cross-sectional illustration showing the fuel flow through the bimetallic thermostatic flow valve with the bimetallic element in the deflectable spring form in the cold start design position of FIG. 6.

FIG. 8 is a cross-sectional illustration of a second embodiment of the bimetallic thermostatic flow valve of the present invention with the bimetallic element in a deflectable plate form in a neutral design position.

FIG. 9A is a cross-sectional illustration of the second embodiment of the bimetallic thermostatic flow valve of the present invention with the bimetallic element in the deflectable plate form in a hot start design position.

FIG. 9B is a cross-sectional view of the second embodiment taken along lines 9B-9B of FIG. 9A to show the shaped deflected bimetallic element.

FIG. 10 is a cross-sectional illustration of the second embodiment of the bimetallic thermostatic flow valve of the present invention with the bimetallic element in the deflectable plate form in a cold start design position.

FIG. 11 is cross-sectional illustration of a third embodiment of the bimetallic thermostatic flow valve having a bimetallic element in the deflectable plate form of the present invention.

FIG. 12 is a schematic illustration of a bimetallic element in the deflectable plate form mounted on a support material suitable for use in the third embodiment of the present invention.

### DETAILED DESCRIPTION

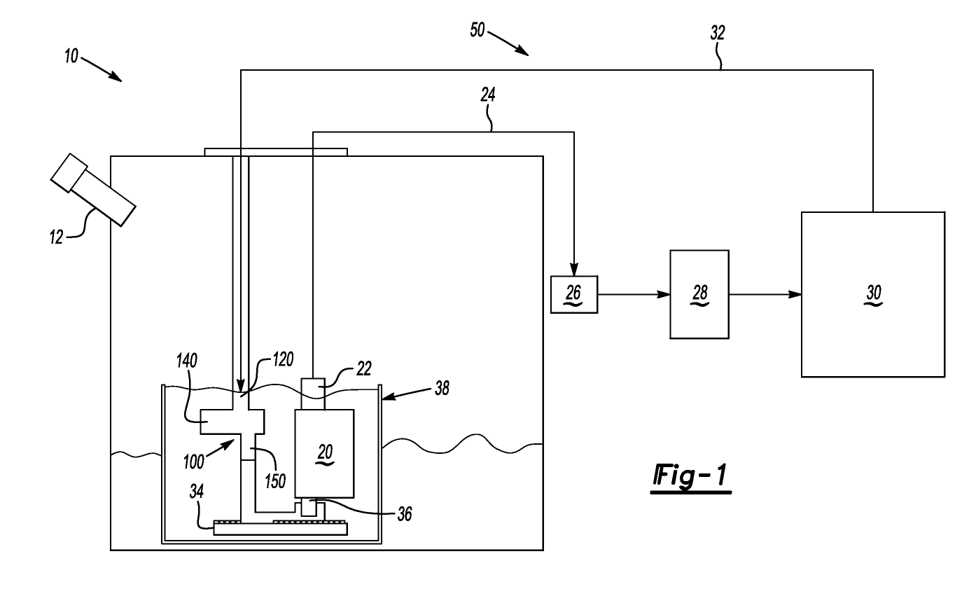

Referring to the drawings, wherein like numbers refer to like components throughout the several views, FIG. 1 shows a fuel system 50 for a diesel engine 30. Diesel fuel is supplied into a fuel supply tank module 10 through a fuel supply tank fill tube 12. Fuel is pumped from the fuel supply tank module 10 by an in-tank low pressure lift pump 20 located inside a fuel pump module reservoir 38 inside the fuel supply tank module 10. Fuel enters the in-tank low pressure lift pump 20 through a fuel pump module inlet strainer 34, which generally is a screen mesh material, and in-tank low pressure lift pump inlet port 36. Fuel moves through the in-tank low pressure lift pump outlet port 22 into a fuel feed supply line 24. The fuel feed supply line 24 connects to a fuel filter module 26 which may include a fuel filter, water separator, and/or heater. The heater in fuel filter module 26 may heat the fuel when it is below a predetermined temperature. A low pressure supply line connects the fuel filter module 26 with a high pressure pump 28 which is mounted on the diesel engine 30. A high pressure supply line connects the high pressure pump 28 with the diesel engine 30. The diesel engine 30 includes a rail with injectors and several other components which are not shown but are well known. Excess fuel not used in the operation of the diesel engine 30 returns to the fuel supply tank module 10 through fuel return line 32. This excess fuel has been heated by the diesel engine 30.

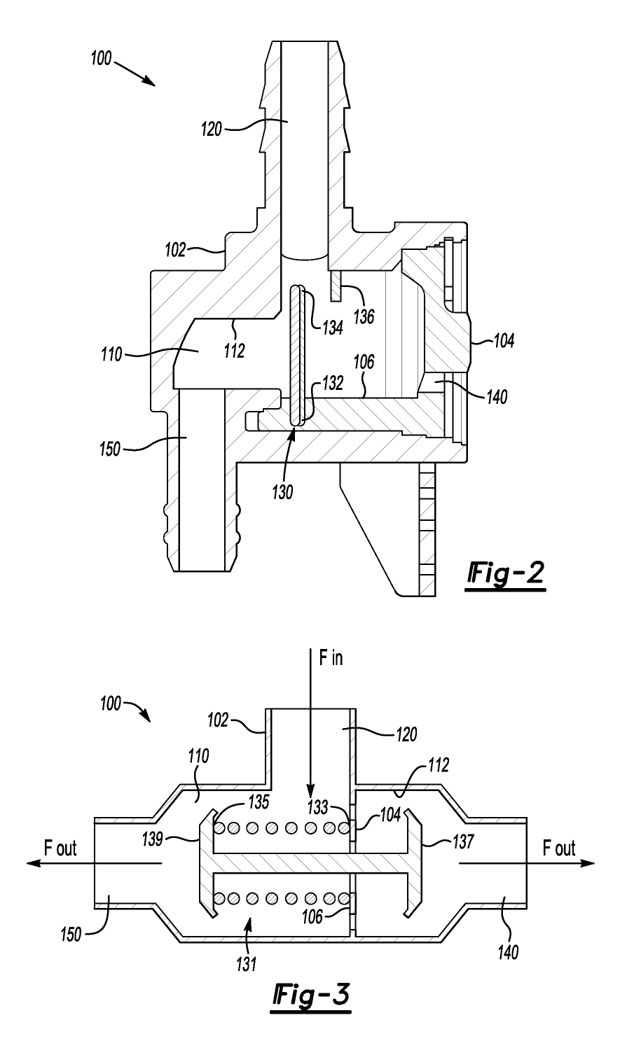

In accordance with the present invention, excess fuel returns through the fuel return line 32 to a fuel return port 120 of a bimetallic thermostatic flow valve 100 located in the fuel pump module reservoir 38 inside the fuel supply tank module 10. As described in more detail in the following description and shown in FIGS. 2, 3, 4, 5, 6 and 7; this excess fuel (called returning fuel throughout this description) flows through the bimetallic thermostatic flow valve 100 causing a bimetallic element 130 or 131 to deflect in response to a temperature of the returning fuel from the fuel return line 32. This bimetallic thermostatic flow valve 100 directs the returning fuel to either one or both of a fuel pump module reservoir port 140 (leading to the fuel pump module reservoir 38) and a fuel supply port 150 (leading to the in-tank low pressure lift pump 20). As shown in FIGS. 2, 4, 6, 8, 9A, 9B, 10, 11 and 12, the bimetallic element may be in the form of a deflectable plate. As shown in FIGS. 3, 5 and 7, the bimetallic element may be in the form of a deflectable spring.

Referring to FIGS. 2 and 3, a first embodiment of the bimetallic thermostatic flow valve 100 includes a valve body 102 having a fuel return port 120 which connects to fuel return line 32 of FIG. 1. The valve body 102 of the bimetallic thermostatic flow valve 100 has a valve body inner wall 112 and an insert member 104 has an insert member inner wall 106. The valve body inner wall 112 and the insert member inner wall 106 form a fuel chamber 110. The bimetallic element 130, 131 is attached to the insert member inner wall 106 at a respective first end 132, 133. Each bimetallic element 130, 131 is composed of temperature responsive material which in effect senses the temperature of the returning fuel.

Referring again to FIGS. 2 and 3, a second end 134, 135 of the respective bimetallic element 130, 131 extends into the fuel chamber 110 of the bimetallic thermostatic flow valve 100 and is in thermal communication with or is free to respond as the temperature of fuel flowing through the fuel return port 120 and into the fuel chamber 110 causes the metals composing the bimetallic element 130, 131 to lengthen or deflect. The bimetallic element 130 in deflectable plate form is shaped to direct or stop the return fuel flow as desired. The bimetallic element 131 in deflectable spring form includes a first spring head 137 and a second spring head 139 shaped to direct or stop the return fuel flow as desired. A stop 136 may be attached to the valve body inner wall 112 of the bimetallic thermostatic flow valve 100 if needed for the bimetallic element 130 to deflect against. The temperature of fuel in (Fin) into the fuel return port 120 is such that the bimetallic element 130, 131 does not deflect fully and thus allows fuel out (Fout) to flow out through both the fuel pump module reservoir port 140 (leading to fuel pump module reservoir 38 shown in FIG. 1) and through the fuel supply port 150 (leading to in-tank low pressure lift pump 20 shown in FIG. 1) depending on the amount of the deflection. This is called a neutral design position for the bimetallic element 130, 131 and could occur when the temperature range of returning fuel is a predetermined temperature range, between 25 and 40 degrees Celsius, for example.

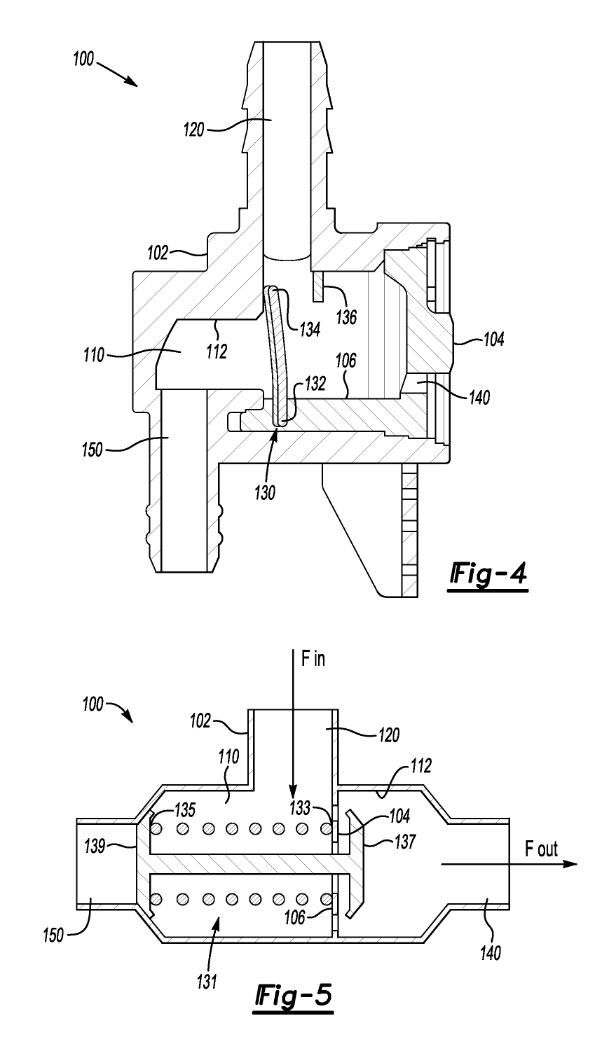

Referring to FIGS. 4 and 5, the first embodiment of the bimetallic thermostatic flow valve 100 having the valve body 102 is shown in which a temperature of fuel is above the predetermined temperature range. The valve body 102 of the bimetallic thermostatic flow valve 100 has the valve body inner wall 112 and the insert member 104 has the insert member inner wall 106. The valve body inner wall 112 and the insert member inner wall 106 form the fuel chamber 110. The bimetallic element 130, 131 is attached to the insert member inner wall 106 at the respective first end 132, 133. Each bimetallic element 130, 131 is composed of temperature responsive material which in effect senses the temperature of the returning fuel.

Referring again to FIGS. 4 and 5, the second end 134, 135 of the respective bimetallic element 130, 131 extends into the fuel chamber 110 of the bimetallic thermostatic flow valve 100 and is in thermal communication with or is free to respond as the temperature of fuel flowing through the fuel return port 120 and into the fuel chamber 110 causes the metals composing the bimetallic element 130, 131 to lengthen or deflect. The stop 136 may be attached to the valve body inner wall 112 of the bimetallic thermostatic flow valve 100 if needed for the bimetallic element 130 to deflect against. The temperature of fuel in (Fin) into the fuel return port 120 is such that the bimetallic element 130, 131 deflects to block the passage or causes the second spring head 139 to block the passage through the fuel supply port 150 respectively, so most of the fuel in (Fin) entering into the bimetallic thermostatic flow valve 100 leaves through the fuel pump module reservoir port 140. This situation occurs when the temperature of fuel in (Fin) is above the predetermined temperature range. By directing most of the fuel out (Fout) to the fuel pump module reservoir port 140, the heated fuel is returned to the fuel pump module reservoir 38 (shown in FIG. 1) and directed away from the diesel engine 30 (shown in FIG. 1), to dissipate excess heat into the bulk fuel in normal vehicle operation. (The temperature above the predetermined temperature range may be above the 25 to 40 degrees Celsius temperature range for example.)

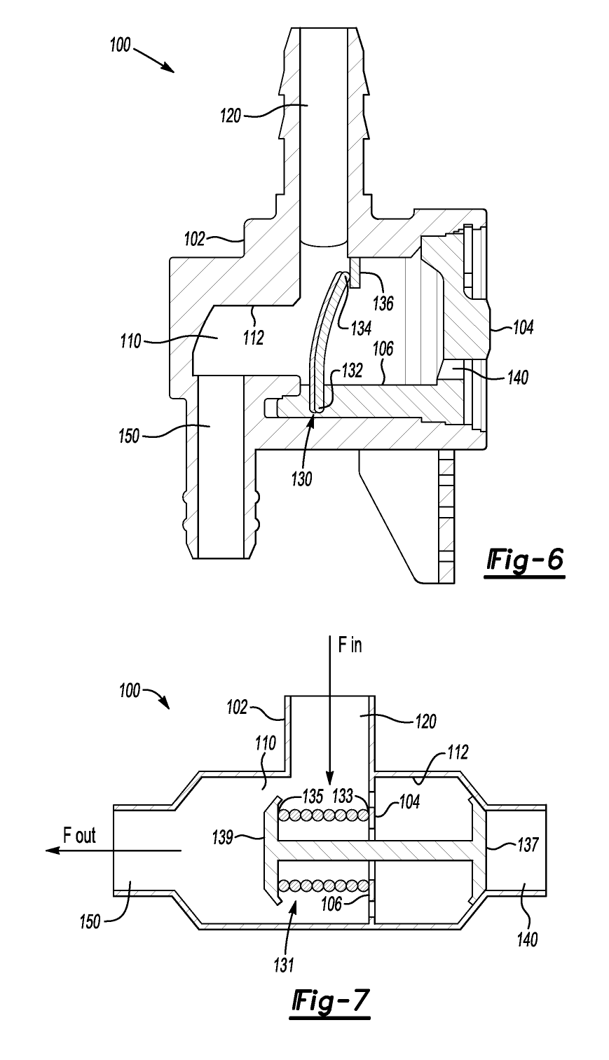

Referring to FIGS. 6 and 7, the first embodiment of the bimetallic thermostatic flow valve 100 having the valve body 102 is shown in which the temperature of fuel is below the predetermined temperature range. The valve body 102 of the bimetallic thermostatic flow valve 100 has a valve body inner wall 112 and an insert member 104 has an insert member inner wall 106. The valve body inner wall 112 and the insert member inner wall 106 form a fuel chamber 110. The bimetallic element 130, 131 is attached to the insert member inner wall 106 at the respective first end 132, 133. Each bimetallic element 130, 131 is composed of temperature responsive material which in effect senses the temperature of the return fuel.

Referring again to FIGS. 6 and 7, the second end 134, 135 of the respective bimetallic element 130, 131 extends into the fuel chamber 110 of the bimetallic thermostatic flow valve 100 and is in thermal communication with or is free to respond as the temperature of fuel flowing through the fuel return port 120 and into the fuel chamber 110 causes the metals composing the bimetallic element 130, 131 to lengthen or deflect. The stop 136 may be attached to the valve body inner wall 112 of the bimetallic thermostatic flow valve 100 if needed for the bimetallic element 130 to deflect against. The temperature of fuel in (Fin) into the fuel return port 120 is such that the bimetallic element 130, 131 deflects to block the passage or causes the first spring head 137 to block the passage through the fuel pump module reservoir port 140, so most of the fuel in (Fin) entering into the bimetallic thermostatic flow valve 100 leaves through the fuel supply port 150. This situation occurs when the temperature of fuel in (Fin) is below the predetermined temperature range. By directing most of the fuel out (Fout) to the fuel supply port 150, the heated fuel is returned to the in-tank low pressure lift pump 20 (shown in FIG. 1) and ultimately the diesel engine 30 (shown in FIG. 1) so that the undesirable effects of cooler fuel may be mitigated. (The temperature below the predetermined temperature range may be below the 25 to 40 degrees Celsius temperature range for example.)

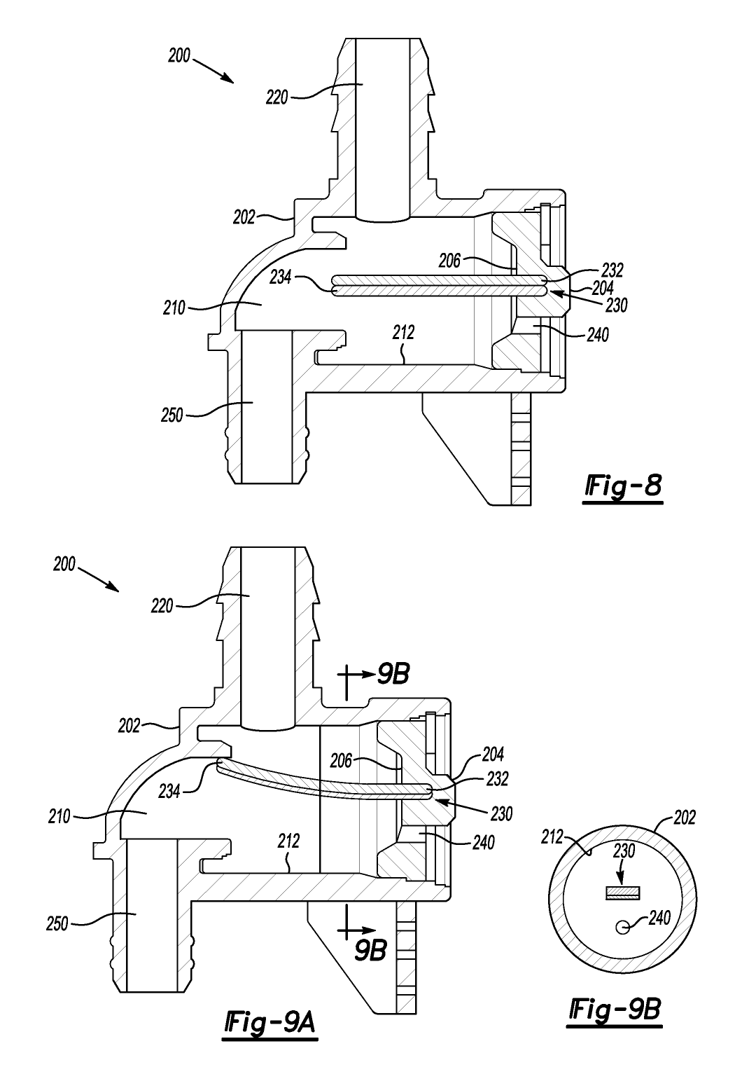

Referring to FIG. 8, a second embodiment of the bimetallic thermostatic flow valve 200 includes a valve body 202 having a fuel return port 220 which connects to a fuel return line (such as shown as the fuel return line 32 in FIG. 1). The valve body 202 of the bimetallic thermostatic flow valve 200 has a valve body inner wall 212 and an insert member 204 has an insert member inner wall 206. The valve body inner wall 212 and the insert member inner wall 206 form a fuel chamber 210. The bimetallic element 230 is attached to the insert member inner wall 206 at a first end 232. The bimetallic element 230 is composed of temperature responsive material which in effect senses the temperature of the returning fuel. A second end 234 of the bimetallic element 230 extends into the fuel chamber 210 of the bimetallic thermostatic flow valve 200 and is in thermal communication with or is free to respond as the temperature of returning fuel flowing through the fuel return port 220 and into the fuel chamber 210 causes the metals composing the bimetallic element 230 to lengthen or deflect. The temperature of the returning fuel into the fuel return port 220 is such that the bimetallic element 230 does not fully deflect and thus, allows fuel to flow out through a fuel pump module reservoir port 240 and through a fuel supply port 250 depending on the amount of the deflection. This is called a neutral design position for the bimetallic element 230 and could occur when the temperature of returning fuel is a predetermined temperature range, between 25 and 40 degrees Celsius, for example.

Referring to FIGS. 9A and 9B, the second embodiment of the bimetallic thermostatic flow valve 200 having the valve body 202 is shown in which the temperature of fuel into the fuel return port 220 is above the predetermined temperature range. The valve body 202 of the bimetallic thermostatic flow valve 200 has the valve body inner wall 212 and the insert member 204 has the insert member inner wall 206. The valve body inner wall 212 and the insert member inner wall 206 form the fuel chamber 210. The bimetallic element 230 is attached to the insert member inner wall 206 at the first end 232. The second end 234 of the bimetallic element 230 extends into the fuel chamber 210 of the valve body 202 of the bimetallic thermostatic flow valve 200 and is free to move as the temperature of returning fuel flowing through the fuel return port 220 causes the metals composing the bimetallic element 230 to lengthen or deflect. Since the returning fuel is above the predetermined temperature range, the bimetallic element 230 deflects to at least partially block the passage through the fuel supply port 250. Most of the fuel entering into the valve body 202 of the bimetallic thermostatic flow valve 200 flows out through the fuel pump module reservoir port 240. Due to the location of the mounting of the bimetallic element 230 in relation to the fuel pump module reservoir port 240, the bimetallic element 230 should be shaped to allow return fuel to travel between the bimetallic element 230 and the inner wall 212 of the valve body 202 of the bimetallic thermostatic flow valve 200 so that more returning fuel goes through the fuel pump module reservoir port 240 than through the fuel supply port 250. This shape as shown in FIG. 9B and described below allows the return fuel to flow around the bimetallic element near the first end 232 and out the fuel pump reservoir port 240. This situation occurs when the temperature of fuel in is above a predetermined temperature. By directing most of the fuel out to the fuel pump module reservoir port 240, the heated fuel is returned to fuel pump module reservoir 38 (shown in FIG. 1) and directed away from fuel system components and the diesel engine 30 (shown in FIG. 1), to dissipate excess heat into the bulk fuel in normal vehicle operation. Referring to FIG. 9B, a cross-sectional view of the shaped deflected bimetallic element of FIG. 9A taken along lines 9B-9B shows that returning fuel may flow between the bimetallic element 230 and the valve body inner wall 212 of valve body 202 so that more of the returning fuel goes through the fuel pump module reservoir port 240.

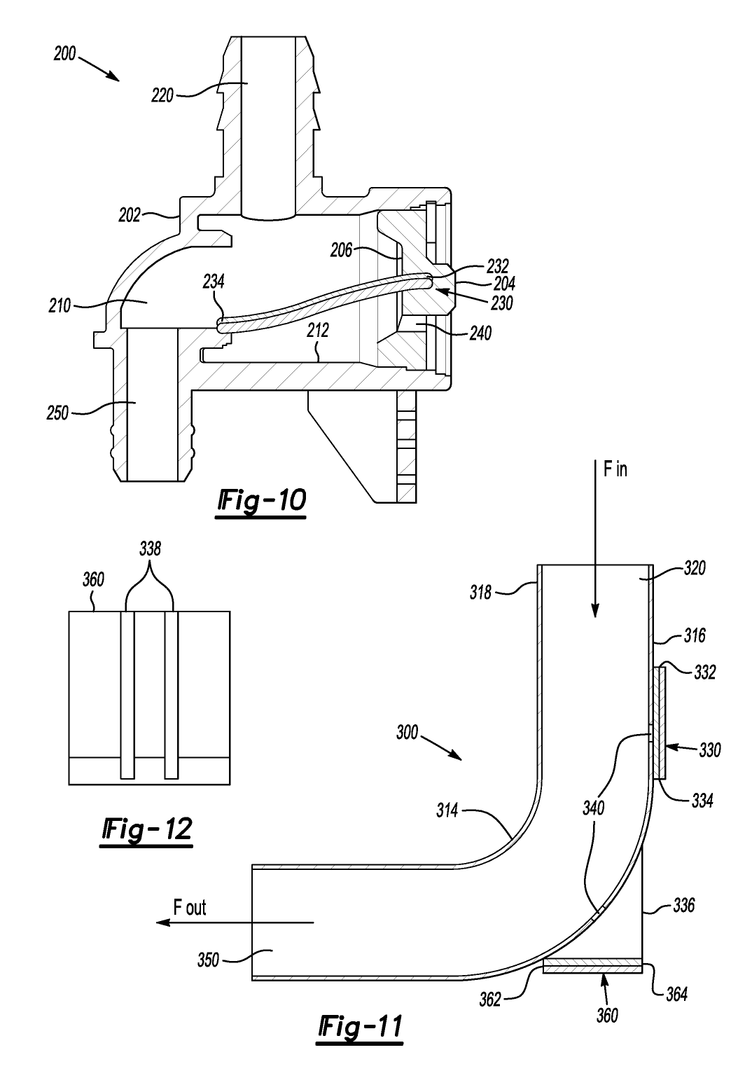

Referring to FIG. 10, the second embodiment of the bimetallic thermostatic flow valve 200 having the valve body 202 is shown in which the temperature of fuel into the fuel return port 220 is below the predetermined temperature range. The valve body 202 of the bimetallic thermostatic flow valve 200 has the valve body inner wall 212 and the insert member 204 has the insert member inner wall 206. The valve body inner wall 212 and the insert member inner wall 206 form the fuel chamber 210. The bimetallic element 230 is attached to the insert member inner wall 206 at the first end 232. The second end 234 of the bimetallic element 230 extends into the fuel chamber 210 of the body 202 of the bimetallic thermostatic flow valve 200 and is free to move as the temperature of returning fuel flowing through the fuel return port 220 causes the metals composing the bimetallic element 230 to lengthen or deflect. As shown in FIG. 10, the temperature of returning fuel into the fuel return port 220 is such that the bimetallic element 230 deflects to at least partially block passage through the fuel pump module reservoir port 240. This situation occurs when the temperature of returning fuel in is below the predetermined temperature range. By directing the returning fuel out to the fuel supply port 250, the heated fuel is returned to in-tank low pressure lift pump 20 (shown in FIG. 1) and ultimately the diesel engine 30 (shown in FIG. 1) so that the undesirable effects of cooler fuel may be mitigated.

Referring to FIG. 11, a third embodiment of the bimetallic thermostatic flow valve 300 is shown in which a standard pipe or generally cylindrical member comprises a valve housing or generally cylindrical valve body 318. The generally cylindrical valve body 318 has a bend 314 and at least one bimetallic element 330 covering at least one aperature 340. If applicable or desired, another bimetallic element 360 covers another aperature 340 and first ends 332 and 362 of the two bimetallic elements 330 and 360 respectively are attached to an exterior wall 316 of the generally cylindrical valve body 318 to cover apertures 340 in the generally cylindrical valve body 318 at cooler returning fuel temperatures. In this third embodiment, the apertures 340 function corresponding to the fuel pump module reservoir ports 140 and 240 in the first and second embodiments of the present invention. When the temperature of the fuel into a fuel return port 320 is below a predefined temperature, fuel flows out of a fuel supply port 350. When the temperature of the returning fuel into the fuel return port 320 becomes great enough (for example over 40 degrees Celsius), second ends 334 and 364 of the bimetallic elements 330 and 360 respectively deflect away from the exterior wall 316 of the generally cylindrical valve body 318 or a stop 336 attached to the exterior wall 316. Thus heated returning fuel is able to flow directly into fuel pump module reservoir 38 (shown in FIG. 1) as the heated returning fuel does not tend to flow through the bend 314 of the generally cylindrical valve body 318 since a straighter flow path has been opened due to the deflection of the bimetallic elements 330 and 360. This deflection allows returning fuel to flow through the apertures 340 which are functioning as fuel pump module reservoir ports in this embodiment. As shown in FIG. 12, to provide more structure to the bimetallic element 360, the bimetallic element may be mounted on a support material 338 such as a piece of plastic, metal or the like as long as the support material deflects with the bimetallic element in response to the temperature of the returning fuel.

The bimetallic portions of the bimetallic elements used in the present invention may include metals which in combination will deflect at a temperature between 15 degrees Celsius and 80 degrees Celsius or other temperatures as system requirements dictate. It is noted that the bimetallic portions of the bimetallic elements may be mounted on additional material which is deflected along with the bimetallic portions when in the presence of heated or cooled fuel. It is further noted that the bimetallic portions should not introduce material into the system which might lead to lower system performance.

While the best modes for carrying out the invention have been described in detail, those familiar with the art to which this invention relates will recognize various alternative designs and embodiments for practicing the invention within the scope of the appended claims.

1. A fuel system for a diesel engine comprising:
a fuel supply tank module for storing fuel, the fuel supply tank module including a fuel pump module reservoir having an in-tank low pressure lift pump and a bimetallic thermostatic flow valve inside the fuel pump module reservoir;
a fuel filter module connected to the in-tank low pressure lift pump for filtering fuel pumped from the fuel supply tank module;
a high pressure pump connected to the fuel filter module for pumping fuel from the fuel filter module;
a diesel engine connected to the high pressure pump for receiving fuel from the high pressure pump; and
a fuel return line connected from the diesel engine to the bimetallic thermostatic flow valve for returning fuel to the bimetallic thermostatic flow valve;
wherein the bimetallic thermostatic flow valve includes a bimetallic element in thermal communication with the returning fuel;
wherein the returning fuel flows through the bimetallic thermostatic flow valve causing the bimetallic element to deflect in response to the thermal communication so that fuel flows to at least one of the fuel pump module reservoir and the in-tank low pressure lift pump.

2. The fuel system according to claim 1, wherein the bimetallic thermostatic flow valve includes a fuel chamber through which the returning fuel flows.

3. The fuel system according to claim 2, wherein the bimetallic thermostatic flow valve has a valve body having a valve body inner wall and an insert member having an insert member inner wall which form the fuel chamber; the bimetallic element has a first end and a second end; and the first end of the bimetallic element is attached to the insert member inner wall and the second end of the bimetallic element extends into the fuel chamber of the bimetallic thermostatic flow valve.

4. The fuel system according to claim 3, wherein the bimetallic thermostatic flow valve further includes a stop on the valve body inner wall for the bimetallic element to deflect against.

5. The fuel system according to claim 1 wherein when the temperature of the returning fuel is above a predetermined temperature range, the bimetallic element deflects so that fuel flows to the fuel pump module reservoir.

6. The fuel system according to claim 1 wherein when the temperature of the returning fuel is below a predetermined temperature range, the bimetallic element deflects so that fuel flows to the in-tank low pressure lift pump.

7. A bimetallic thermostatic flow valve comprising:
a valve body having:
a fuel return port, a fuel pump module reservoir port, a fuel supply port, and a fuel chamber connected to the fuel return port and through which returning fuel flows; and
a bimetallic element extending into the fuel chamber and in thermal communication with the returning fuel; wherein the returning fuel causes the bimetallic element to deflect in response to the thermal communication so that fuel flows to at least one of the fuel pump module reservoir port and the fuel supply port.

8. The bimetallic thermostatic flow valve of claim 7, wherein when the temperature of the returning fuel is above a predetermined temperature range, the bimetallic element deflects to direct the returning fuel to the fuel pump module reservoir port.

9. The bimetallic thermostatic flow valve of claim 7, wherein when the temperature of the returning fuel is below a predetermined temperature range, the bimetallic element deflects to direct the returning fuel to the fuel supply port.

10. The bimetallic thermostatic flow valve of claim 7 wherein the bimetallic thermostatic flow valve has a valve body having a valve body inner wall and an insert member having an insert member inner wall which form the fuel chamber; the bimetallic element has a first end and a second end; and the first end of the bimetallic element is attached to the insert member inner wall and the second end of the bimetallic element extends into the fuel chamber of the bimetallic thermostatic flow valve.

11. The bimetallic thermostatic flow valve of claim 10 wherein the bimetallic thermostatic flow valve further includes a stop on the valve body inner wall for the bimetallic element to deflect against.

12. The bimetallic thermostatic flow valve of claim 7 wherein the bimetallic element is a deflectable plate.

13. The bimetallic thermostatic flow valve of claim 7 wherein the bimetallic element is a deflectable spring.

14. A bimetallic thermostatic flow valve comprising:
a generally cylindrical valve body having a bend and having at least one aperture, the generally cylindrical valve body including a fuel return port and a fuel supply port, for directing returning fuel flow;
wherein the at least one aperture has a bimetallic element covering the at least one aperture and wherein the bimetallic element deflects away from the at least one aperture in response to a predetermined temperature of returning fuel flowing through the generally cylindrical valve body.

15. The bimetallic thermostatic flow valve of claim 14 wherein the generally cylindrical valve body has an exterior wall and the bimetallic element has a first end which is attached to the exterior wall of the generally cylindrical valve body.

16. The bimetallic thermostatic flow valve of claim 15 wherein the generally cylindrical valve body further includes a stop attached to the exterior wall of the generally cylindrical valve body for the bimetallic element to deflect against.

17. The bimetallic thermostatic flow valve of claim 14 wherein the bimetallic element is mounted on a support material.
